(19) United States
(12) Patent Application Publication
(10) Pub. No.: US 2014/0107887 A1
(43) Pub. Date: Apr. 17, 2014

(54) VEHICLE WITH FAULT ISOLATION AND RESPONSE CONTROL

(71) Applicant: Jay E. Bissontz, Fort Wayne, IN (US)

(72) Inventor: Jay E. Bissontz, Fort Wayne, IN (US)

(73) Assignee: International Truck Intellectual Property Company, LLC, Lisle, IL (US)

(21) Appl. No.: 14/119,944

(22) PCT Filed: Jun. 22, 2011
(86) PCT No.: PCT/US11/41334

§ 371 Date: Nov. 25, 2013

(51) Int. Cl. G07C 5/08

(52) U.S. Cl. CPC G07C 5/0808
USPC 701/34.4; 701/29.2

(57) ABSTRACT

In a vehicle data network with power storage and distribution systems, a ground fault detector or ground insulation monitoring device provides detection of power leakages. Integrity of the power system is reported to a body computer connected to the data network. Responsive to detection of leakage, controllers for high voltage sub-systems report out of norm power usage compared to expected power demand. The system can take corrective actions including: indicating to the operator occurrence of a ground fault; indicating the likely to the source of the fault; reconfiguring operation of the sub-system which is the likely source of the fault, including turning the sub-system off but not otherwise restricting vehicle operation; turning the sub-system off or limiting its operation after a limited time allowing the operator to configure the vehicle for restricted operation; or, placing the vehicle in a restrictive mode of operation.

### BACKGROUND

1. Technical Field

The technical field relates generally to vehicles incorporating high voltage direct current systems, particularly electric and hybrid electric vehicles and, still more particularly, to identifying and responding to ground faults on such vehicles.

2. Description of the Technical Field

The interest in meeting demand for improved motor vehicle fuel economy has seen ever greater penetration of hybrid vehicles into the motor vehicle market including the market for trucks. Various hybrid architectures exist but particularly popular are hybrid electric architectures employing a high voltage traction batteries. In one architecture the high voltage traction batteries are used to store electrical power from and supply electrical power to an alternating current electrical machine though a DC/AC (direct current/analog current) inverter/converter at potentials up to or exceeding 700 volts DC. There is has also been an increase in interest in using high voltage electric motors to support accessories such as air conditioning, power steering and pneumatic system air compressors, both on conventional vehicles as well as on electric hybrid vehicles.

Fuel economy gains are achieved by using electric motors to power accessories and occur notwithstanding electrical resistance losses which occur in generating and storing electrical power. There are several reasons for this. Electric motors, in contrast to powering the accessories directly from the vehicle's thermal engine, are readily operated only as needed. Electric motors can be run at the minimum level needed to meet the instantaneous power demands of each particular accessory. Power can be drawn from the vehicle battery avoiding any need for the thermal engine to be running at the time power is drawn, potentially reducing thermal engine parasitic losses.

Each of the high voltage loads represented by accessory motors, as well as the traction motor, is a potential location for a ground fault. As with conventional vehicles, the mass of the vehicle itself serves as a ground reference for the electrical system. Substantial resistance may exist between different parts of the vehicle raising the possibility that different parts of the vehicle's physical structure may be at substantially different electrical potential levels as a result of a ground fault.

Ground fault detection is routinely provided on electric and hybrid vehicles. An example of a device for detecting fault currents is disclosed in U.S. Pat. No. 6,392,422 to Kammer et al. A related example of a ground fault detector is sold by W. Bender Gmbh & Co. KG of Grünberg, Germany under the mark “A-isometer” including particularly this firm's “IR155-3204” model. This device generates a pulsed measurement voltage which is superimposed on the high voltage power distribution system. The device applies the signal every five minutes and monitors the chassis for appearance of the signal. When fault conditions are recognized an indication signal is generated.

### SUMMARY

Where a vehicle incorporates a data network such as a controller area network and where a high voltage power storage and distribution system employs a ground fault detector or ground insulation monitoring device to detect power leakages to the vehicle chassis ground, integrity of the power storage and distribution system is reported to a body computer over the data network. Responsive to detection of leakage, controllers for individual high voltage sub-systems report out of norm power usage compared to expected power demand. The body computer can then direct appropriate corrective actions including: indicating to the vehicle operator the occurrence of a ground fault; indicating a sub-system likely to the source of the fault; reconfiguring operation of the sub-system which is the likely source of the fault including turning the sub-system off or reducing its operational level with selected restriction on operation of the vehicle; turning the sub-system off or limiting its operation after a limited period of time to allow the vehicle operator to remove the vehicle from service.

### BRIEF DESCRIPTION OF THE DRAWINGS

FIG. 1 is a side elevation of a truck and trailer system which may be equipped with a hybrid electric drive train.

FIGS. 2A and 2B are high level block diagrams of a control system for the truck of FIG. 1.

FIG. 3 is a high level flow chart illustrating operation of the system.

### DETAILED DESCRIPTION

In the following detailed description, like reference numerals and characters may be used to designate identical, corresponding, or similar components in differing drawing figures. Furthermore, example sizes/models/values/ranges may be given with respect to specific embodiments but are not to be considered generally limiting.

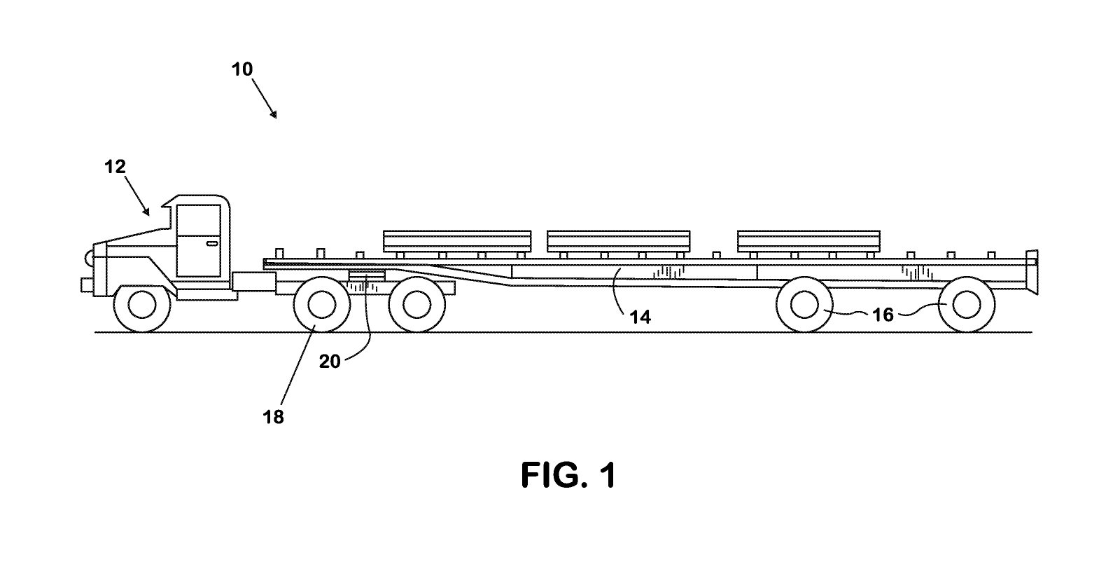

Referring now to the figures and in particular to FIG. 1, a truck/trailer combination 10 comprising a hybrid truck 12 with a trailer 14 attached thereto along the axis of a fifth wheel 20 is shown. Trailer 14 rides on a plurality of wheels 16. Truck 12 rides a combination of wheels 16 and drive wheels 18. Drive wheels 18 are connected to a hybrid electric drive train for locomotion. The rotation of wheels 16 and drive wheels 18 can be retarded to stop the vehicle through service brake system 99 which is actuated using a pneumatic system. The rotation of drive wheels 18 can also be retarded by using them to back drive the hybrid electric drive train 19 to generate electricity (often termed dynamic or regenerative braking).

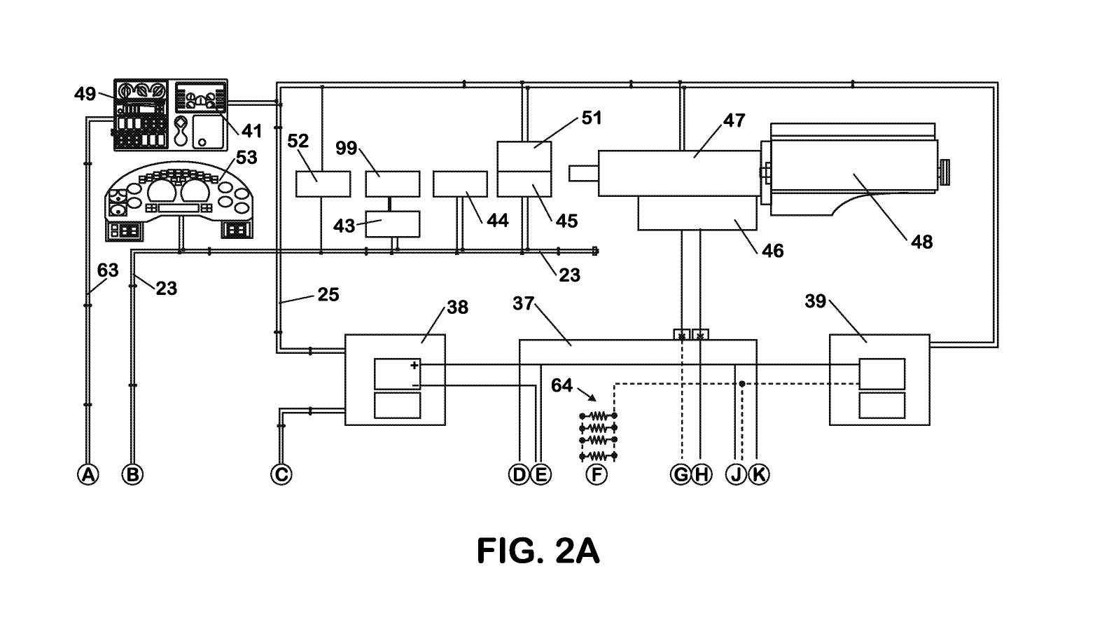

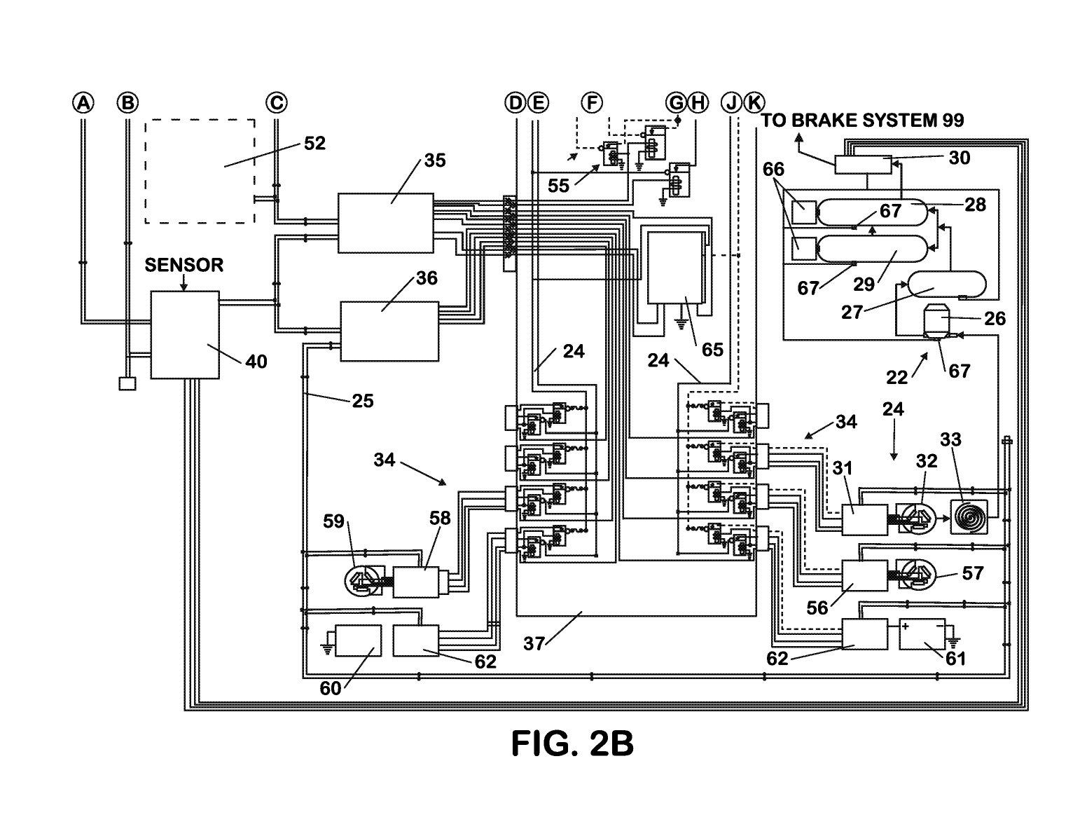

FIGS. 2A and 2B are high level schematic of an electric power distribution system and an associated control system representative of systems which can be used with hybrid electric drive train 19. Power flow is routed through a high voltage distribution box 37 to which are attached two high voltage battery sub-packs 38 and 39, the high voltage inverter/converter 46, a plurality of high voltage DC controllers 31, 56 and 58 for DC electric motors 32, 57 and 59 and a pair of bi-directional DC/DC converters 62. DC electric motors 32, 57 and 59 relate to operation of a pneumatic compressor 33, an HVAC compressor (not shown) and a power steering system (not shown). DC/DC converters support an low (12 volt) DC vehicle electrical system which includes 12 volt chassis batteries 60, 61.

Hybrid electric drive train 19 is represented as a parallel system, though the present disclosure is not limited to such systems. The hybrid electric drive train 19 includes a thermal/internal combustion (IC) engine 48, a dual mode electric machine 47 which may be run in an electric traction motor mode or which may be back driven from drive wheels 18 (or thermal engine 48) for operation in an electrical generator mode. Electric machine 47 may be a three phase alternating current (AC) machine (including synchronous machines). Electrical power is converted to direct current for storage and distribution. Connection between the DC systems and the electric machine 47 is through a high voltage inverter/converter 46 which operates on 700 volts DC on its direct current power distribution system side and high voltage, variable frequency, three phase alternating current on the electric machine 47 side of inverter/converter 46.

Traction batteries are installed in high voltage battery sub-packs 38, 39. These receive power generated by the dual mode electrical machine 47 in its generator mode, supply power to the electrical machine in its traction motor mode and stabilize power distribution system voltage. Each battery sub-pack supports a 350 volt DC potential difference and are connectable in series across the inputs to the high voltage inverter/converter 46 to supply 700 volts DC to the inverter/converter 46.

Electrical power to drive the dual mode electrical machine 47 as a traction motor is delivered to the dual mode electrical machine through an inverter/converter 46 through a high voltage distribution box 37 from high voltage traction battery sub-packs 38, 39. Power generated by the dual mode electrical machine 47 when in its generator mode passes through the inverter/converter 46 back to high voltage battery sub-packs 38, 39 for storage during regenerative braking up to the rate of charge limits and total charge capacity of the high voltage battery sub-packs 38, 39. Use of a split battery plant, that is two high voltage battery sub-packs 38, 39, allows distribution of direct current (DC) power through the high voltage distribution box 37 to accessory motors at 350 volts DC. Collectively the high voltage traction battery sub-packs 38, 39, or any other arrangement of one or more traction batteries, may be termed a battery plant.

Power is distributed to high voltage accessory motors and to DC/DC convertors 62 for a 12 volt electrical power storage and distribution system at 350 volts DC. First and second sets of contactors comprising isolation contactors 55 and accessory contactors 34 respectively control power routing. Associated with contactors 55 are a plurality of pre-charge resistors 64 for limiting initial current inflow. The operation of the contactors 55 and pre-charge resistors 64 is conventional with the pre-charge resistors being switched out of the circuit after a brief initialization period on start up. Contactors 55 control the delivery of power to the inverter/converter 46 and to the 350 volt DC buses. Located within the high voltage distribution box 37 is a ground fault detector 65. Ground fault detector 65 is connected to power buses 24 and can insert pulsed signals onto the power buses 24 and from there into the high voltage inverter/converter 46, the accessory motors 32, 57, 59 and to the DC/DC converters 62. Ground fault detector is further connected to the vehicle ground reference to detect appearance of corresponding responses to the inserted pulsed signals at the vehicle ground reference and for reporting the detected strength of the inserted pulsed signal to the vehicle control system. Reporting can occur over a connection to a remote power module (RPM) 35 which functions as an extension of a electronic system controller (ESC) 40 (a type of body computer) and also controls the states of sets of isolation contactors 55 and accessory contactors 34. The high voltage distribution box 37 provides connection points from the power buses 24 through accessory contactors 34 and through motor controllers 31, 56 and 58 to accessory motors 32, 57 and 59. Accessory contactors 34 also provide power couplings to bi-directional DC/DC converters 62 through which power is transmitted to, and drawn from, first and second twelve-volt chassis batteries 60, 61.

Over all vehicle control is implemented through a plurality of data links and controllers of which only a few functional details are of interest here. There are two high capacity buses/controller area network/data links 23 and 25 which provide the back bones for a drive train controller area network (CAN) and a hybrid controller area network (CAN), respectively. Data links 23, 25, the controllers connected thereto conform to the physical requirements of the Society of Automotive Engineers J1939 standard and implement a communications protocol conforming to its standards. There is a lower capacity bus 63 conforming to the SAE J1708 protocol used to convey switch state information from a dash panel 49 to ESC 40. A driver display 41 relating to hybrid system condition is connected to hybrid data link 25.

Control is implemented using a plurality of programmable controllers interconnected by data links 23, 25. The controllers generally relate to major vehicle systems as identified by their names, for example, the anti-lock brake system (ABS) controller 43. ABS controller 43 measures wheels 16, 18 rotational speed and provides data allowing involved in control over the truck/trailer combination 10 service brake system 99 and control over individual brakes. ABS controller 43 data can also provide data to be used to calculate truck/trailer 110 speed. Other controllers include a transmission control unit (TCU) 42, an engine valve control module 44, an engine control unit (ECU) 45, battery management controllers associated with high voltage traction battery sub-packs 38 and 39 and a hybrid control unit (HCU) 51. In addition, ESC 40 provides integration functions and handles control over the states of the contactors 34, 55 of the high voltage distribution box 37 through programmable remote power modules (RPM) 35, 36. In addition ESC 40 provides supervisory control over manifold solenoid valve assembly (MSVA) 30 and compressor motor controller 31 relating to pneumatic system 22. RPM's 35, 36 may be treated as generic controllers through which the ESC 40 operates on accessory systems and from which it can receive data.

The controllers connected to ESC 40 over one or both of the data links 23, 25, and sensors directly connected to ESC 40 or which can communicate to ESC 40 through another controller, provide data relating to truck 12 operating variables which in turn relate to expected power consumption by dual mode electrical machine 17, one the accessory motors 32, 57, 59 or the DC/DC converters 62. To take an example, either the ABS controller 43 or TCU 42 may be used to generate an estimate of vehicle speed. Vehicle speed is in turn inversely related to power consumption by the power steering motor 59 provided the rate of change in the angle of the wheels used for turning is constant. Another example would be demands on HVAC compressor motor 57. Power consumption by this motor for air conditioning will be related to outside ambient temperature and the cabin temperature request made by the operator.

Controllers may be connected to either or both of the CAN data links 23, 25. As configured here ESC 40 and TCU 42 are connected to both the drive train data link 23 and to the hybrid data link 25. Gauge cluster and controller 53 and the engine valve control module 44 are connected only to the drive train data link 23. The hybrid control unit 51 and ECU 45 communicate directly and with the hybrid data link 25 and drive train data link 23 respectively. The battery management systems (BMS) controllers for the high voltage traction battery sub-packs 38, 39 are connected to the hybrid data link 25 only, as is a heating, ventilation and air conditioning (HVAC) pusher fan controller 52. RPMs 35, 36 are controlled over the hybrid data link 25 from ESC 40. Networked interaction made possible by CAN technology means that the ESC 40 has access to data relating to a number of vehicle operating conditions such as vehicle speed (which relates to power steering power demands), ambient temperature (which relates to air conditioner compressor power demands, and so on. This allows expected power demands to be compared with actual power consumption.

RPMs 35, 36 provide direct control over contactors 34, 55. ESC 40 controls motor controllers 58, 56 and 31 over hybrid data link 25 and thus controls the electrical compressor motor 32 which is the prime mover for pneumatic system compressor 33.

Interaction of one of the high voltage accessory systems with the high voltage distribution system illustrates one functional aspect of the present disclosure. The foundation or service brake system 99 may be used for this illustrative purpose. Foundation brake system 99 is supported by pneumatic system 22 which operates as a vehicle accessory system driven by electric compressor motor 32 and pneumatic compressor 33. Compressor motor controller 31 and the electric compressor motor 32 draw electrical power from the traction batteries or the dual mode electrical machine 47. The pneumatic system includes a pneumatic compressor 33 which supplies compressed air to compressed air supply and storage tanks 27, 28 and 29 and an air dryer 26. A valve controller (MSVA) 30 allows use of compressed air from the storage tanks to operate purge valves 67 for the dryer tank, to supply air to the service brake system 99 and other tasks.

Pneumatic system compressor 33 supplies compressed air to an air dryer 26 which in turn supplies a supply tank 27 from which the compressed air is delivered to primary and secondary air tanks 28, 29. Purge valves 67 may be provided air dryer 26 and both the primary and secondary air tanks 28, 29. Control over air distribution to the service brake system 99, between the various storage tank (not shown) and over a purge line to purge valves 67 is handled by a manifold solenoid valve assembly (MSVA) 30 which itself is under the direct control of ESC 40 in communication with requests from ABS controller 43. Service brake system 99 is to be taken as encompassing ABS sensors and the actual service brakes attached to wheels 16, 18. Typically the service brake system 99 is the primary consumer of compressed air from primary and secondary air tanks 28, 29 although other pneumatic systems may be installed on the vehicle, such as an air starter for the IC/thermal engine 48.

ESC 40 is also provided with connections (not shown) to receive pressure signal measurements from pressure sensors 66. Pressure sensors 66 are connected to the primary and secondary air tanks 28, 29. Successive pressure readings may be used by the ESC 40 to develop rate of pressure change values as well which can be used to trigger operation of electric compressor motor 32. Static pressure measurements are also used to trigger pressurization of primary and secondary storage tanks 28, 29. Overcoming current static pressure during pneumatic compressor 33 operation substantially explains compressor motor 32 power consumption. The existing vehicle data link 23, 25 environment is utilized to control the operation of the existing chassis and hybrid electric vehicle components, systems and subsystems, particularly the compressor motor 32 and at least one electromagnetic pneumatic controlled purge valve 67 for condensed moisture from the vehicle's pneumatic system.

ESC 40 interprets the pressure measurement series and generates CAN communications to broadcast the primary and secondary tank 28, 29 over either or both CAN data links 23, 25. Reconfigurable software and the electronic control architecture allow control over the operation of a pneumatic compressor 33 which draws in air at ambient atmospheric pressure and compresses it for delivery to air dryer 26. The determination as to whether or not a particular pneumatic compressor 33 should be operated and at what level/rate (e.g., angular velocity, torque and duration) is a factor of the pressure sensor 66 pressure measurements and the rate of change of pressure in the vehicle's primary and secondary tanks 28, 29. The indicated pressure level produced by pressure sensors 66, reported to the ESC 40 allows an estimate to be generated by the ESC of the power that should be drawn by electric compressor motor 32 to drive pneumatic compressor 33 to deliver air to pneumatic system 22. Compressor motor controller 31 develops actual power usage measurements and from the measurements can determine if departures from expected power consumption have occurred, an event which may indicate location of a ground fault if time correlated with such an indication from the ground fault detector 65. Expected power consumption estimates may be programmed as look up tables in memory accessible by ESC 40 or the appropriate controller. The look up tables may be interrogated by the measured vehicle operating variables.

Responsive to detection of a ground fault reported over either CAN from ESC 40, individual controllers for individual high voltage sub-systems can report out of norm power usage compared to expected power demand on the CAN. ESC 40 can then take appropriate corrective actions and indicate the fault on the driver display 41. For example, if the fault appears to have occurred in the high voltage inverter/converter 46, truck 12 may be taken out of hybrid operational mode and motive power supplied exclusively by the internal combustion/thermal engine 48. In order to extend operational range electrical power rationing may be imposed so that accessory systems essential to vehicle operation, such as power steering and brakes 99 continue to be available. Non-essential systems such as air conditioning and drains on the 12 volt DC system may be turned off (particularly if the fault appears to be in a non-essential sub-system). If the fault appears related to a sub-system needed for truck 12 operation, such as the compressor motor 32 for the pneumatic system 22, the operator may be given a limited time period to get the vehicle off the road, or, preliminary to such a step, the pneumatic system may be placed in a reduced operational state by reducing target air pressure to 90 psi from 120 psi to see if the ground fault indication can be eliminated.

In general, steps which may be taken to control or isolate a ground fault include: indicating to the vehicle operator the occurrence of a ground fault; indicating the system likely to the source of the fault; reconfiguring operation of the sub-system which is the likely source of the fault including turning the sub-system off but not otherwise restricting operation of the vehicle; turning the sub-system off or limiting its operation after a limited period of time which allows the vehicle operator to configure the vehicle for restricted operation; or, placing the vehicle in a restrictive mode of operation.

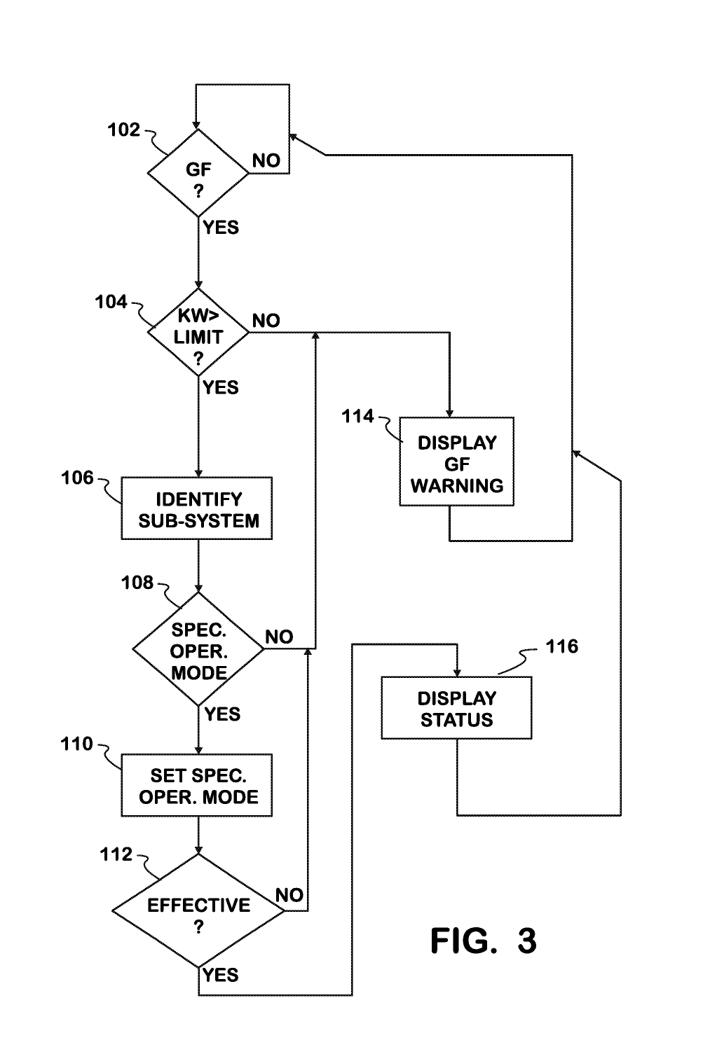

In broad overview these operations are represented in the flow chart of FIG. 3 where upon indication of a ground fault (step 102) by the ground fault detector 65 it is determined whether a high voltage component is consuming excess power (or generating less power than expected where the dual mode electrical machine 47 is backdriven) under current vehicle operating conditions (step 104). Where no high voltage component or sub-system is operating outside of expected power ranges (the NO branch) a ground fault is indicated and the operator may be advised to seek repair or other advice given (step 114). Where a component or sub-system is operating outside of expected ranges (the YES branch from step 106) the system is identified (step 106) and step 108 taken to determine if additional responses are available. If such steps are available operation continues to step 110 to implement the steps. Examples of steps that can be taken which would allow continued normal operation of the vehicle include disabling the air conditioning at step 112. Whatever restrictions on operation are imposed the operator is advised of the condition and the extent to which reduced functionality has been imposed on the vehicle.

What is claimed is:

1. A vehicle comprises:
a direct current power distribution system having a ground reference in the vehicle;
a ground fault detector for generating indication of a ground fault;
a plurality of loads connected to the direct current power distribution system;
data storage providing expected power consumption values for each of the plurality of loads; and
a data processing system including controllers relating to the loads for providing measured power consumption values for each of the plurality of loads and connected to receive indication of a ground fault and to compare measured power consumption values with expected power consumption values for developing an indication of a source of the ground fault.

2. A vehicle as set forth in claim 1, the data processing system further comprising:
a data link;
a body computer; and
the body computer and the controllers communicating over the data link.

3. A vehicle as set forth in claim 2, further comprising:
a dual mode electrical machine having a traction mode and a generation mode; and
traction batteries connectable to the dual mode electrical machine for supplying power to the dual mode electrical machine in its traction mode and receiving power from the dual mode electrical machine in its generation mode.

4. A vehicle as set forth in claim 3 wherein the dual mode electrical machine is installed in a hybrid electric drive train.

5. A vehicle as set forth in claim 3, further comprising:
sensor inputs to the body computer providing values relating to vehicle operating variables;
the controllers being programmed to develop additional values relating to vehicle operating variables;
power consumption estimates for a plurality of the loads for different values of the vehicle operating variables.

6. A vehicle as set forth in claim 5, further comprising:
sets of vehicle operational responses to identification of a specific load as source of a ground fault including one or more of following; turning the specific load off, reducing the operational level of the specific load, applying selected restriction on operation of the vehicle, delaying an operational response to allow a vehicle operator to remove the vehicle from service.

7. A vehicle as set forth in claim 6 wherein the dual mode electrical machine is installed in a hybrid electric drive train.

8. A vehicle comprising:
a dual mode three phase electrical machine having a generation mode and a traction mode;
a direct current power distribution and storage system;
an inverter/converter connecting the dual mode three phase electrical machine to the direct current power distribution and storage system;
a plurality of direct current loads connected to the direct current power distribution and storage system;
a plurality of controllers for the direct current loads;
a body computer;
a controller area network linking the plurality of controllers and the body computer for data communication;
sources of data relating to vehicle operating variables;
a ground fault detector;
means for generating estimates of direct current loads power consumption for, responsive to the data relating to vehicle operating variables, values for expected direct current loads power consumption; and
means responsive to indication of a ground fault and excessive direct current load power consumption for identifying a direct current load as a location of a ground fault.

9. A vehicle as set forth in claim 8, further comprising:
sets of vehicle operational responses programmed into the controllers which, upon identification of a direct current load as source of a ground fault, include turning the load off or reducing its operational level with selected restriction on operation of the vehicle or turning the load off.

10. A vehicle as set forth in claim 9, further comprising:
means for providing delay of any of the sets of vehicle operation responses for a limited period of time.
